(19) United States
(12) Patent Application Publication
(10) Pub. No.: US 2001/0039603 A1
(43) Pub. Date: Nov. 8, 2001

(54) DEVICE BAY STORING SOLID STATE MEMORY CARDS

(76) Inventor: NEAL MANOWITZ, SAN JOSE, CA (US)

Correspondence Address: FINNEGAN HENDERSON FARABOW, GARRETT & DUNNER, 1300 I STREET NW, WASHINGTON, DC, 200053315

(21) Appl. No.: 09/239,717

(22) Filed: Jan. 29, 1999

(51) Int. Cl. G06F 12/00

(52) U.S. Cl. 711/115; 711/147; 711/148

(57) ABSTRACT

A memory bay in a network of devices is capable of holding an arbitrary number of memory modules, which together form a shared network memory. The memory modules may be dynamically inserted or removed from the memory bay while the memory bay is connected to the network. Inserting or removing memory modules changes the memory capacity of the network.

### BACKGROUND

The present invention relates generally to digital memory, and, more particularly, to a modular digital memory storage device in a dynamically changeable network of consumer electronic devices.

Recent advances in digital bus technology make possible dynamic network connection/disconnection of a variety of consumer electronic and computing devices. One such bus standard is the IEEE-1394 digital interface standard. The IEEE-1394 digital interface is a serial digital interface enabling high-speed (up to 400 Mbps) data communication among multimedia equipment such as video camcorders, electronic still cameras, computers, and digital audio/visual equipment. Features of the IEEE-1394 include live connection/disconnection without data loss or interruption; automatic configuration supporting “plug and play”; and freeform network topology allowing mixing branches and daisy-chains. More complete information regarding IEEE-1394 is available from the Institute of Electrical and Electronics Engineers (IEEE).

FIG. 1 is a diagram illustrating an exemplary network of devices coupled through an IEEE-1394 interface, The network includes digital video camera 100, digital video monitor 102, personal computer 104, digital VCR 106, and printer 108. The devices communicate digital video data with one another via the IEEE-1394 interface. Because the video carried on the IEEE-1394 bus is digital, each device can process the video directly in the digital domain without the expense and image quality loss incurred when converting back and forth to analog. There is no need for a video capture card or any analog-to-digital conversion—the entire data path is digital. The monitor, computer, and VCR accept the digital data and display or store the data as appropriate.

Digital information, such as the images and sound produced by digital video camera 100, must be stored to be useful. Storing the information inside computer 104 or video camera 100, although possible, is not without its disadvantages. For example, computer 104 and video camera 100 are relatively large, cumbersome devices that most users would prefer to not have to move just to transport their data to another location. Although this problem can be partially alleviated by saving the data to a transportable medium such as a computer floppy disk, displaying the data in another IEEE-1394 network requires that the other network contains a computer capable of reading the floppy disk.

Thus, there is a need in the art to be able to easily transport, store, and read digital information using a storage medium that is recognized by and can be directly accessed by all devices in a network.

### SUMMARY OF THE INVENTION

Methods and systems consistent with the present invention allow transportable memory modules to be easily inserted or removed from a memory bay. The memory modules can be accessed by a plurality of types of devices in a network.

More specifically, a shared memory device consistent with this invention includes a memory device bay having a plurality of memory slots, each slot configured to accept a memory module, the total capacity of the memory device bay being at least equal to the sum of memory capacities of each memory module inserted in the memory device bay; and a logic circuit to process requests from a plurality of consumer electronic devices to retrieve or store data.

Another aspect of the present invention is directed to a network comprising a memory device bay and at least one memory module dynamically insertable and removable from the memory device bay, the memory module having a predetermined amount of memory. A device coupled to the memory device bay accesses the memory module through the memory device bay.

Still another aspect of the present invention is directed to a solid state memory module. The module includes a solid state memory array; logic circuitry for controlling data access to the solid state memory array; a rechargeable battery supplying power to the solid state memory array; and contact pads for connecting the solid state memory to external devices and for supplying power to the rechargeable battery.

### BRIEF DESCRIPTION OF DRAWING

The accompanying drawings, which are incorporated in and constitute a part of this specification, illustrate several embodiments consistent with this invention and, together with the description, help explain the principles of the invention. In the drawings,

FIG. 1 is a diagram illustrating a conventional network of devices coupled through an IEEE-1394 interface;

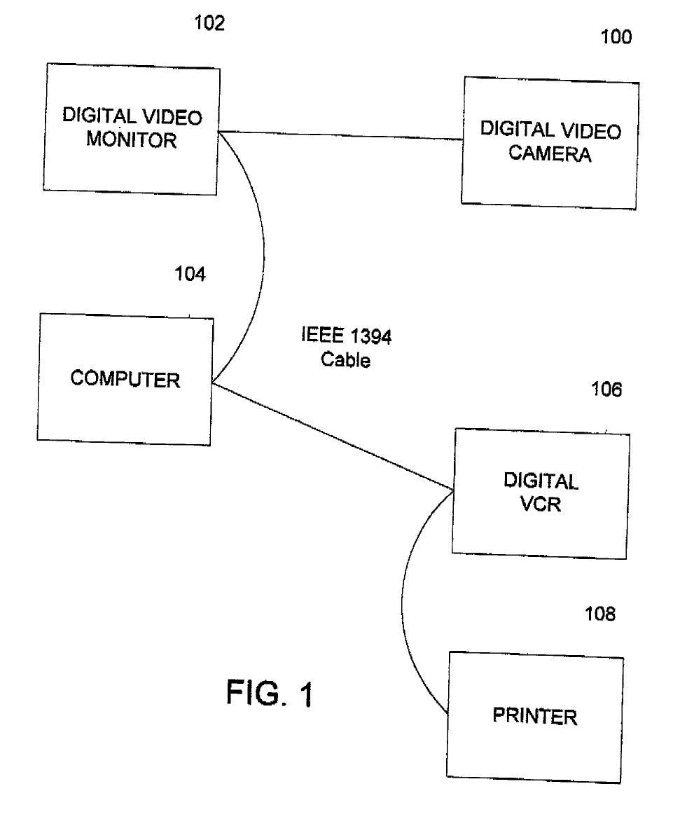

FIG. 2 is a diagram illustrating an exemplary network of devices coupled through an IEEE-1394 interface in a manner consistent with the present invention;

FIG. 3 a diagram illustrating a detailed view of a memory device bay; and

FIG. 4 is a diagram illustrating a memory module.

### DETAILED DESCRIPTION

As described herein, a memory bay in a network of devices is capable of holding an arbitrary number of memory modules, which together form a shared network memory. The memory modules may be dynamically inserted or removed from the memory bay while the memory bay is connected to the network. Inserting or removing memory modules changes the memory capacity of the network.

Reference will now be made in detail to embodiments of the invention, examples of which are illustrated in the accompanying drawings. Wherever possible, the same reference numbers will be used throughout the drawings to refer to the same or like parts.

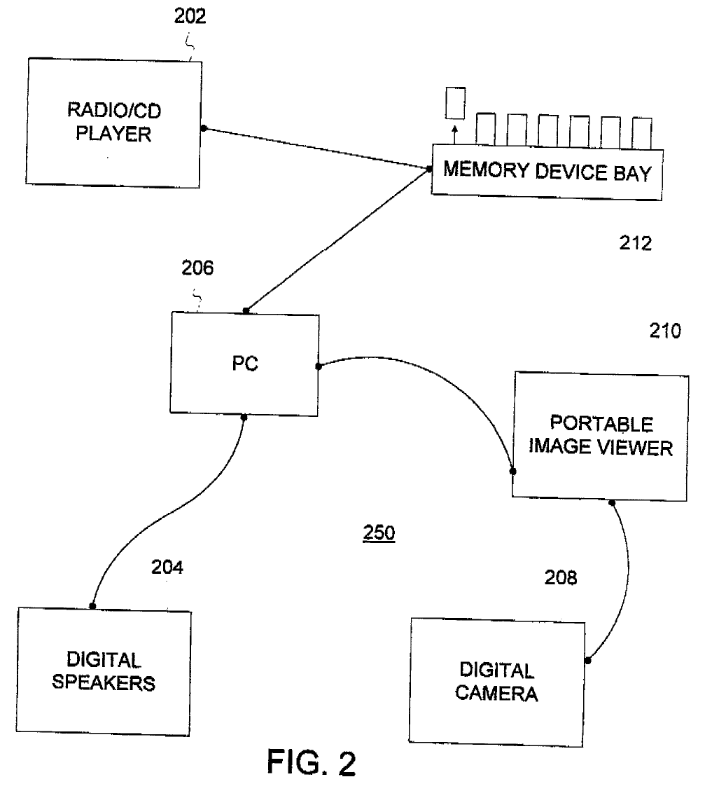

FIG. 2 is a diagram illustrating a network 250 of IEEE-1394 enabled devices. Specifically, as shown, the network includes radio/CD player 202, digital speakers 204, personal computer 206, digital camera 208, and image viewer 210.

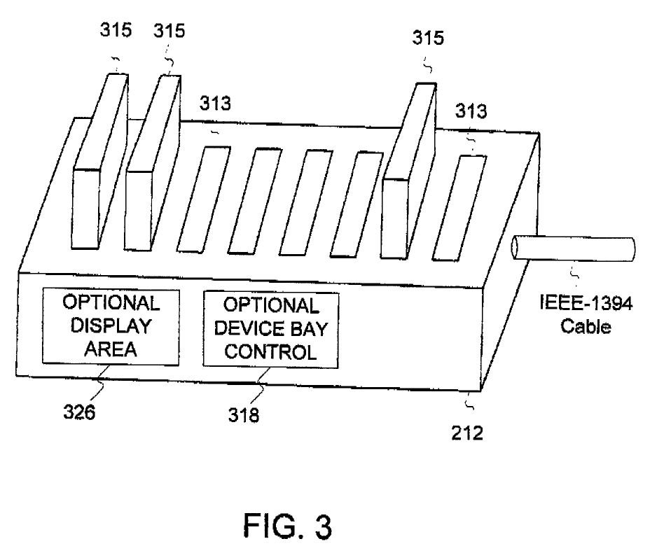

Network 250 additionally includes memory device bay 212, which is shown in more detail in FIG. 3. Device bay 212 includes a plurality of slots 313 in which removable memory modules 315 may be inserted or removed. Memory modules 315 each have a predetermined memory capacity (e.g., 1 megabyte), although the memory capacity of two different memory modules 315 need not be identical. The total memory capacity of memory device bay 212 at any time is the stun of all inserted memory modules plus any additional memory in the device bay itself. Consistent with the live connection/disconnection feature of the IEEE-1394 standard, memory modules 315 can be dynamically inserted or removed from device bay 212 while the device bay is active and coupled to other devices in the network. To accomplish this, device bay 212 includes a logic circuit for processing requests from the consumer electronic devices to retrieve or store data. The logic circuit includes a transceiver compatible with an IEEE-1394 bus.

Network 250, although shown as being physically implemented with cables (wires), may also be implemented as a wireless network, or as a combination of a wireless and wired network.

Devices 202, 204, 206, 208, and 210 may access and use, via the network, the memory modules inserted in device bay 212. In this manner, device bay 212 functions as a shared network memory resource. In addition to accessing memory modules 315 stored in device bay 212, devices 202, 204, 206, 208, and 210 may also directly accept the memory modules.

Memory device bay 212 my optionally include a processor controlling an LCD display area 326. Display area 326 is controlled by the processor to display information relating to the status of the device bay. The information displayed may include, for example, the total memory capacity of the memory modules inserted in the device bay, the amount of available unused memory, error information relating to the memory modules, or the type of digital data stored in the memory modules (e.g., image information or audio information). Alternatively, instead of display area 326, status information may be transmitted and viewed at personal computer 206, or at other devices in the network.

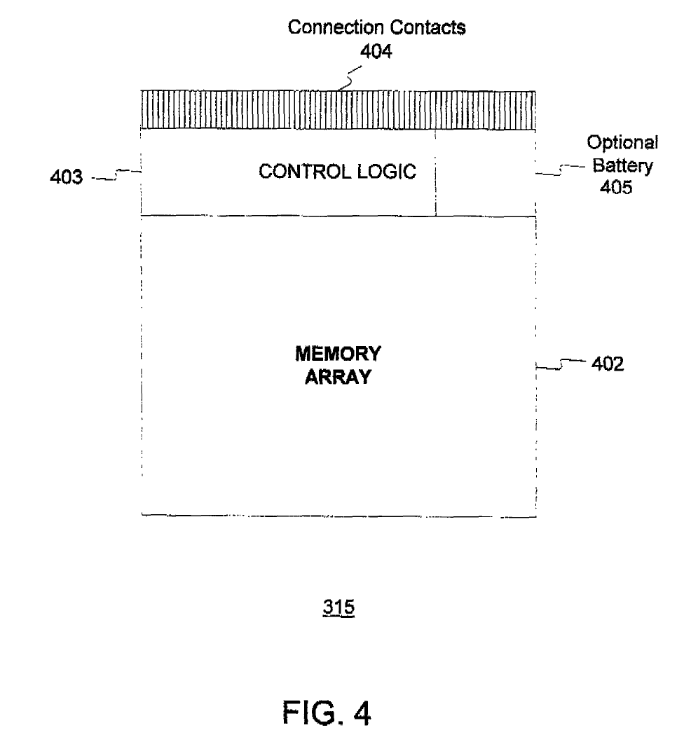

FIG. 4 is a diagram illustrating one of memory modules 315. Memory modules 315 include memory cells, organized into a memory array 402, for storing digital data. Memory array 402 is accessed by control logic 403. Data being transferred from or to memory module 315 is transferred through data contacts 404.

The memory cells in memory array 402 may be either non-volatile, such as flash RAM, or volatile, such as SRAM or DRAM. Volatile memory requires a constant source of power. Accordingly, if memory array 402 is made of volatile memory cells, it preferably also includes power source 405, such as a battery. When removed from device bay 212, the battery provides power to memory array 402, preserving the data in the memory module. The battery may be a rechargeable battery that automatically recharges with power from device bay 212 whenever its memory module is inserted.

Memory module 315 inserted in device bay 212 may be accessed by devices in the network to read or write data to the memory modules. Alternatively, some of memory modules 315 may be read-only, which means that devices in the network can read the data in the memory modules, but cannot write data to the memory modules. Memory module 315, may be, for example, a Sony Memory Stick™.

As discussed, data stored in memory device bay 212 is stored in one or more memory modules 315. The organization of the data storage, that is, what data is stored on which modules, may be controlled automatically by the device bay 212 or may be under the direction of the user, either through controls, such as controls 318 located on device bay 212, or through software at computer 206. In this manner, the user can decide what information is stored/accessed in which memory module. This allows the user to create collections of related information, such as a memory module dedicated to family portraits or to favorite songs.

A device bay and its corresponding memory modules, as described above, provide a convenient transportable device for carrying and storing information. Any type of digital data may be stored in the memory modules, including image/video information, audio information, computer programs, or electronic books. Further, the user may control the allotment of the data to the memory modules, allowing the user to build “libraries” of memory modules relating to a particular type of data.

It will be apparent to those skilled in the art that various modifications and variations can be made to the present invention without departing from the scope or spirit of the invention. For example, although the device bay and memory module were described in the context of a network based on the IEEE-1394 standard, other bus architectures may be used (e.g., USB). Additionally, although memory modules 315 were described as having solid state memory, other types of memory may be used, such as magnetic based memory media (e.g., hard disks).

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. A shared memory device comprising
a memory device bay having a plurality of memory slots, each slot configured to accept a memory module, the total capacity of the memory device bay being at least equal to the sum of memory capacities of each memory module inserted in the memory device bay; and
a logic circuit for processing requests from a plurality of consumer electronic devices to retrieve or store data.

2. The device of claim 1, wherein the logic circuit comprises a transceiver compatible with an IEEE-1394 bus.

3. The device of claim 1, wherein the logic circuit comprises a transceiver designed to implement a wireless connection.

4. A network comprising:
a memory device bay;
at least one memory module dynamically insertable and removable from the memory device bay, the memory module having a predetermined amount of memory; and
a device coupled through a network to the memory device bay and accessing the memory module through the memory device bay.

5. The network of claim 4, wherein the device and the memory module are coupled through the network using a digital standard.

6. The network of claim 4, wherein the device is a digital consumer electronic device.

7. The network of claim 4, wherein the memory module contains flash memory.

8. The network of claim 4, wherein the memory module contains volatile memory.

9. The network of claim 8, wherein the memory module includes a rechargeable battery for providing power to the volatile memory, the rechargeable battery being recharged by the memory device bay when the rechargeable battery is inserted in the memory device bay.

10. The network of clam 5, wherein the device and the memory module are coupled together using an IEEE-1394 bus standard.

11. The network of claim 4, wherein the memory module is a digital storage device.

12. A solid state memory module comprising:
a solid state memory array;
logic circuitry for controlling data access to the solid state memory array;
a rechargeable battery supplying power to the solid state memory array; and
contact pads for connecting the solid state memory to external devices and for supplying power to the rechargeable battery.

13. A method of adding memory to a network, which includes a consumer electronic device, comprising the steps of:
inserting a memory module into a memory device bay of the network;
dynamically adjusting the memory capacity of the memory device bay based on the capacity of the inserted memory module; and
storing information in the inserted module corresponding to a device coupled to the memory device bay when the device accesses the memory module through the memory device bay.
